(19) United States
(12) Patent Application Publication
(10) Pub. No.: US 2018/0137539 A1
(43) Pub. Date: May 17, 2018

(54) CONTEXT ASSOCIATION

(71) Applicant: OPEN TEXT CORPORATION, Waterloo (CA)

(72) Inventor: Roger Khemraj Brooks, Sunnyvale, CA (US)

(21) Appl. No.: 15/570,248

(22) PCT Filed: May 1, 2015
(86) PCT No.: PCT/US2015/028932

§ 371 Date: Oct. 27, 2017

(51) Int. Cl. G06Q 30/02; G06Q 50/00

(52) U.S. Cl. CPC G06Q 30/0269; G06Q 50/01; G06Q 30/0201; G06Q 30/0204

(57) ABSTRACT

A method is provided in accordance with an aspect of the present disclosure. The method includes obtaining at least one attribute of a contact, and obtaining context information related to a plurality of contexts, where each context is associated with a set of segments of contacts, a distance metric, and at least one promoted item. The method also includes, for each context in the plurality of contexts, determining a distance between the contact and the context by determining, using the distance metric associated with each context, a shortest distance between the contact and each of the segments associated with the context. The method further includes associating the contact with the at least one promoted item associated with the context having a shortest distance from the contact.

### BACKGROUND

Marketing of new and existing products or services is an important tool for many organizations and business. Marketing helps these organizations and business to communicate the value of their products or services to potential consumers (also called contacts) for the purpose of influencing buyer behavior. In many situations, the pool of potential consumers to which these businesses or organizations may offer their products or services is extremely large.

### BRIEF DESCRIPTION OF THE DRAWINGS

FIG. 1 is a schematic illustration of an example of a system for constructing market segments of consumers in accordance with an implementation of the present disclosure.

FIG. 2 illustrates a flow chart showing an example of a method for constructing market segments of consumers in accordance with an implementation of the present disclosure.

FIG. 3 illustrates an example contextual space for at least one attribute related to a plurality of consumers in accordance with an implementation of the present disclosure.

FIG. 4 illustrates a flow chart showing an example of a method for identifying an optimal number of clusters in accordance with an implementation of the present disclosure.

FIGS. 5 and 6 illustrate a flow chart showing an example of a method for constructing a plurality of segments of similar consumers by using the clusters identified by the method of FIG. 4 in accordance with an implementation of the present disclosure.

FIG. 7 illustrates a flow chart showing an example of an alternative method for constructing market segments of consumers in accordance with an implementation of the present disclosure.

FIG. 8 illustrates a flow chart showing an example of a method for associating a contact with at least one promoted item.

FIG. 9 illustrates a flow chart showing an example of a method for determining a matching context for a contact.

### DETAILED DESCRIPTION

As mentioned above, organizations and businesses often rely on various marketing tools to communicate the value of their products or services to potential consumers (also referred to as contacts). In many situations, the pool of potential consumers is so large that a decision maker (e.g., a marketer) may have difficulty selecting what are the best groups or segments of potential consumers for which products or services. In addition, marketers or decision makers often have a limited marketing budget, so identifying matching segments of potential consumers for a given product, identifying matching products for a given consumer, and/or choosing the appropriate marketing mechanism to market the matching products to a given consumer, may increase marketer's efficiency and consumers' satisfaction. Due to the vast number of products, marketing mechanisms, consumers and their characteristics, and the complicated correlations between these factors, it may not be feasible to perform these tasks manually.

With the continued developments in technology, the interaction between vendors (e.g., suppliers of products or services), marketers, and consumers has been replaced by a digital relationship. That trend transitioned traditional marketing to digital marketing, which uses various electronic devices (e.g., personal computers, smartphones, tablets, etc.) and electronic platforms or methods of communication (e.g., websites, e-mail, mobile applications, etc.) to engage with potential consumers. Many organizations combine their marketing efforts in both traditional and digital marketing channels. Digital marketing allows marketers to have a direct one-on-one interaction with potential consumers (e.g., when consumers visit the vendor's website, receive an email from the vendor, etc.). Therefore, it is very important for marketers to successfully market their products or services to the potential consumers during that direct interaction. This may be achieved by first identifying segments of similar consumers.

One way of identifying segments of similar consumers is to analyze the behavior of these consumers and to group them according to their similar behavioral characteristics. Dividing a large group of consumers to segments of consumers that have idiosyncratic characteristics or behavior helps the marketers to present a unique marketing experience to each segment in order to influence the consumers to purchase their products or services.

In order to track the results or the success of their marketing campaign, decision makers or marketers may use a Key Performance Indicator (“KPI”). The KPI may differ widely depending on the marketer's budget, goals, and objectives. Therefore, the ultimate goal of marketers or decision makers is to identify segments of consumers that are aligned with the chosen KPI.

Systems, methods, and computer readable media discussed herein propose evaluating the behavior of proposed consumers by assessing their responses to digital stimulus (e.g., promotion by email, on a website, social media, etc.) during an event (i.e., a contact of the consumer with the marketer by visiting a website, opening an email, etc.) in the digital channel. For example, each consumer and each event in the digital channel may be characterized by a set of attributes. These attributes can be used by marketers to optimize the identified KPI. Each of the attributes for each potential consumer may be associated with a specific attribute value for every consumer.

In some examples, attributes related to the consumer may be defined based on a probability distribution of a context (e.g., a quantifier such as marketer's KPI) in relation to attribute values of each of the attributes for all consumers, such that “contextual space” for each attribute may be constructed. The contextual space may be a non-Euclidean topological space over the values of the attribute(s) with a metric derived from the probability distribution of the context given each attribute's values for each consumer. Using the metric (also referred herein as the “distance metric”), the solution determines clusters of consumers based on the probability distribution of the context in relation to the attribute values of the attribute for all consumers. Segments of similar consumers may then be identified based on the clusters. Each of the identified segments may include potential consumers that have similar attribute values in relation to the KPI and, therefore, these consumers may have similar characteristics. The quality of the identified segments is based on their alignment with the marketer's KPI.

As used herein, the terms “marketer,” “decision maker”, and “vendor” may be used interchangeably and refer to any of the parties that may be responsible for promoting or marketing products or services to potential consumers and for distributing a budged related to that. It is to be understood that the vendor (i.e., the supplier of products and services) and the marketer (i.e., the promoter of products and services) may or may not be the same party.

As used herein, the term “segment” refers to a group of potential or actual consumers that is selected from a larger pool or set of potential or actual consumers. The segment of consumers is identified based on their attributes in relation to the marketer's KPI such that a marketer may directly exploit these characteristics to identify and target consumers who are best aligned with the KPI and may have a greater success in marketing their products or services.

As used herein, the term “KPI” refers to a tool or an indicator used by marketers to track the results of their marketing efforts and campaigns. The types of KPI can differ between different marketers based on the marketers' budget, goals, and objectives. For example, a common KPI used by many marketers is the number of items of one or more products or services sold as a result of the marketing campaign.

As used herein, the term “attribute” refers to a characteristic or a property of a participant in a collection of data (e.g., a consumer), which can be either directly measured or inferred. An attribute may be related to a KPI, such as to characterize a consumer in a manner relevant to the KPI. An attribute may also be related to various consumer data: demographic data (e.g., marital status, gender, age, race, etc.); geographic data (e.g., home country, home city, zip code, etc.); psychographic data (e.g., personality: outgoing, ambitious, introverted, etc.; lifestyle: suburban, urban, settled, blue-collar, mid-life success, student, etc.); affinity/product/brand data (e.g., product purchase history, product features desired/needed, etc.); clickstream/transactional data (e.g., page view ID; visitor ID; visitor IP address, etc.); social media data (e.g., referrals, hares, likes, follows, etc.) and any other type of data.

In some examples, an attribute may also be related to an event in the digital channel. As used herein, the term “event in the digital channel” refers to any direct digital contact between a consumer and a vendor or a marketer. Such event may include visiting the vendor's website, opening an email from the vendor or the marketer, clicking on a link provided by the vendor or the marketer, or any other type of even in the digital channel. Thus, in some examples, a consumer may be associated with one or more attributes describing one or more events in the digital channels, i.e., the manner in which the particular consumer arrived at the marketer's website, the particular page on which the consumer landed, etc.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

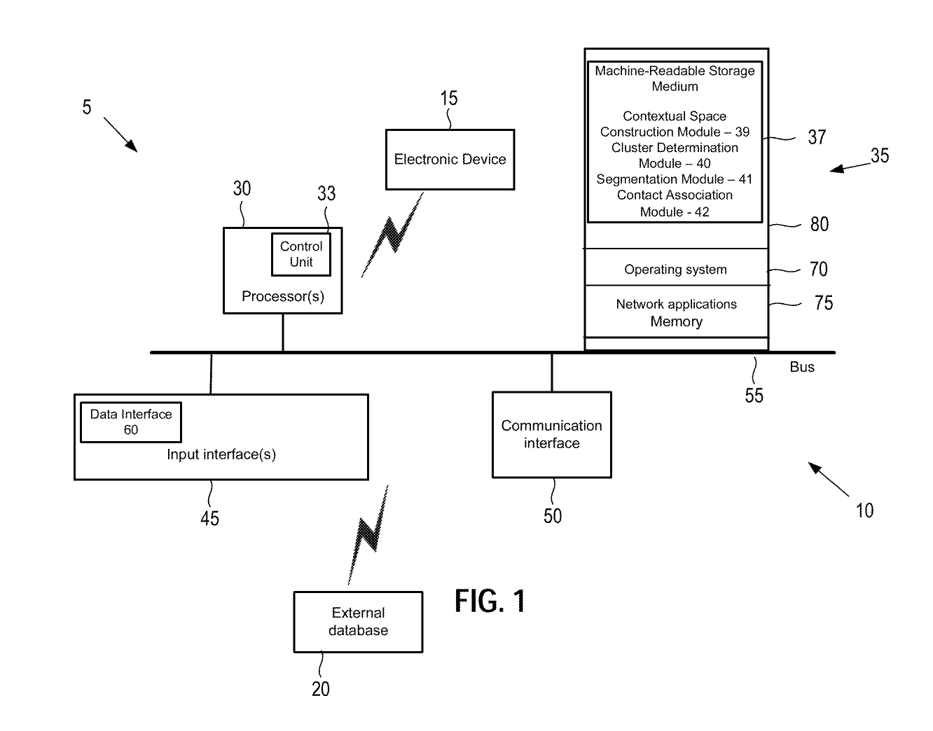

FIG. 1 is a schematic illustration of an example of a system 5. The system 5 may include at least one computing device 10 capable of carrying out the techniques described below. The computing device 10 may be a personal computer, a laptop, a server, a mobile device, a plurality of distributed computing devices, or any other suitable computing device. In the illustrated example, the computing device 10 includes at least one processing device 30 (also called a processor), a memory resource 35, input interface(s) 45, and communication interface 50. In other examples, the computing device 10 includes additional, fewer, or different components for carrying out the functionality described herein.

As explained in additional detail below, the computing device 10 may include software, hardware, or a suitable combination thereof configured to enable functionality of the computing device 10 and to allow it to carry the techniques described below and to interact with the one or more external systems/devices. For example, the computing device 10 includes communication interfaces (e.g., a Wi-Fi® interface, a Bluetooth® interface, a 3G interface, a 4G interface, a near filed communication (NFC) interface, etc.) that are used to connect with external devices/systems and/or to a network (not shown). The network may include any suitable type or configuration of network to allow for communication between the computing device 10 and any external devices/systems.

For example, the computing device 10 may communicate with at least one electronic device 15 (e.g., a computing device, a server, a plurality of distributed computing devices, etc.) or with an external database 20 to receive input data related to a plurality of potential consumers or any other type of information. It is to be understood that the operations described as being performed by the computing device 10 that are related to this description may, in some implementations, be performed or distributed between the computing device 10 and other computing devices (not shown).

The processing device 30 of the computing device 10 (e.g., a central processing unit, a group of distributed processors, a microprocessor, a microcontroller, an application-specific integrated circuit (ASIC), a graphics processor, a multiprocessor, a virtual processor, a cloud processing system, or another suitable controller or programmable device), the memory resource 35, the input interfaces 45, and the communication interface 50 are operatively coupled to a bus 55.

The communication interface 50 may allow the computing device 10 to communicate with plurality of networks, communication links, and external devices. The input interfaces 45 may receive information from any internal or external devices/systems in communication with the computing device 10. In one example, the input interfaces 45 may include at least a data interface 60. In other examples, the input interfaces 45 may include additional interfaces. In one implementation, the data interface 60 receives communications from the electronic device 15 or the external database 20. The communications may include at least information related a group of potential consumers. In some example, that information may include at least one attribute related to each of the consumers (or multiple attributes related to each of the consumers), an attribute value of the at least one attribute for each consumer, and at least one predetermined KPI.

The processor 30 may include a controller 33 (also called a control unit) and may be implemented using any suitable type of processing system where at least one processor executes computer-readable instructions stored in the memory 35. The memory resource 35 may include any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, an SD card, and other suitable magnetic, optical, physical, or electronic memory devices. The memory resource 35 may also be used for storing temporary variables or other intermediate information during execution of instructions to by the processor 30.

The memory 35 may also store an operating system 70 and network applications 75. The operating system 70 may be multi-user, multiprocessing, multitasking, multithreading, and real-time. The operating system 70 may also perform basic tasks such as recognizing input from input devices, such as a keyboard, a keypad, a mouse; sending output to a projector and a camera; keeping track of files and directories on memory 35; controlling peripheral devices, such as printers, image capture device; and managing traffic on the bus 55. The network applications 75 may include various components for establishing and maintaining network connections, such as computer-readable instructions for implementing communication protocols including TCP/IP, HTTP, Ethernet®, USB®, and FireWire®.

Software stored on the non-transitory machine-readable storage media 37 and executed by the processor 30 may include, for example, firmware, applications, program data, filters, rules, program modules, and other executable instructions. The control unit 33 may retrieve from the machine-readable storage media 37 and execute, among other things, instructions related to the control processes and methods described herein. In one example, the instructions stored in the non-transitory machine-readable storage media 37 may implement a contextual space construction module 39, a cluster determination module 40, a segmentation module 41, and contact association module 42. In other examples, the instructions may implement more or fewer modules (e.g., various other modules related to the operation of the system 5). In one example, modules 39-42 may be implemented with electronic circuitry used to carry out the functionality described below. As mentioned above, in addition or as an alternative, modules 39-42 may be implemented as a series of instructions encoded on a machine-readable storage medium and executable by a processor.

As explained in additional detail below, the contextual space construction module 39 may construct a contextual space for at least one attribute related to each consumer, where the contextual space defines the at least one attribute based on a probability distribution of the KPI in relation to the attribute values of the at least one attribute for all consumers (e.g., the contextual space may define a metric for the at least one attribute). In addition, the cluster determination module 40 may perform clustering in the contextual space to identify optimal number clusters of consumers. The segmentation module 41 may construct a plurality of segments of similar consumers by using the clusters. The contact association module 42 may, among other things, obtain contact information about a contact (e.g., a consumer) and find, among a plurality of predetermined (e.g., previously defined) contexts, the closest context to the contact.

Information and data associated with the system 5 and other systems/devices can be stored, logged, processed, and analyzed to implement the control methods and processes described herein. For example, the memory 35 may include at least one database 80. In other example implementations, the system 5 may access external database (e.g., database 20) that may be stored remotely of the computing device 10 (e.g., can be accessed via a network or a cloud). The database 80 or the external database 20 may be a customer relationship management (“CRM”) databases for the vendor or the merchant.

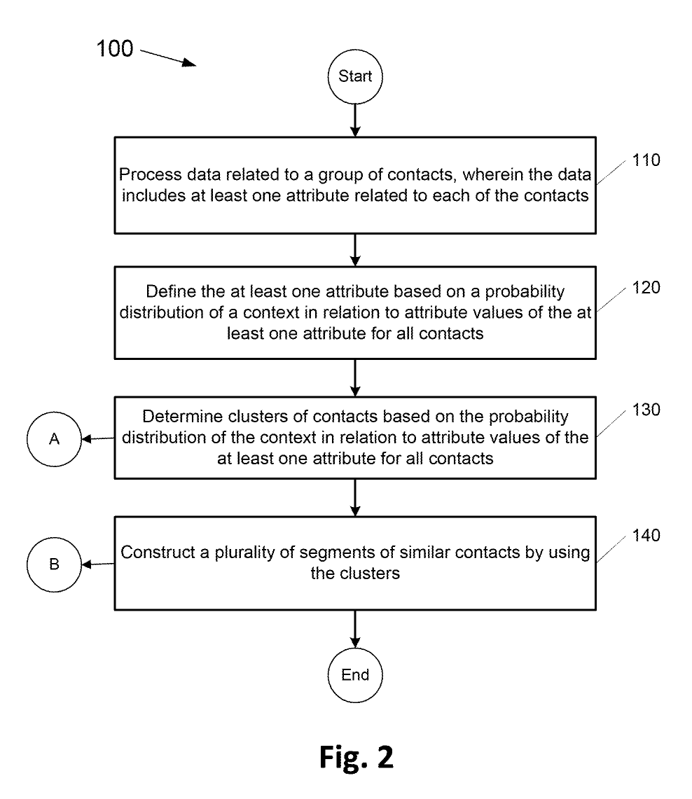

FIG. 2 illustrates a flow chart showing an example of a method 100 for constructing market segments of consumers. In one example, the method 100 can be executed by the control unit 33 of the processor 30 of the computing device 10. Various elements or blocks described herein with respect to the method 100 are capable of being executed simultaneously, in parallel, or in an order that differs from the illustrated serial manner of execution. The method 100 is also capable of being executed using additional or fewer elements than are shown in the illustrated examples.

The method 100 may be executed in the form of instructions encoded on a non-transitory machine-readable storage medium 37 executable by the processor 30 of the computing device 10. In one example, the instructions for the method 100 implement the contextual space construction module 39, the cluster determination module 40, and the segmentation module 41. In other examples, the execution of the method 100 may be distributed between the processing device 30 and other processing devices in communication with the processing device 30. In the implementation related to FIG. 2, the computing device 10 may be a device of a vendor or a marketer and may be controlled by the vendor or the marketer. Alternatively, the computing device 10 may be operated by a third party that provides services to a vendor or a marketer.

The method 100 begins at block 110, where the processor 30 processes data (e.g., an input dataset) related to a group of consumers. The processed input dataset may be collected or received from any appropriate private or publically available source (e.g., the electronic device 15, the external database 80, or any other system or device) or may be stored on the database 80. In the alternative, the data may be collected by the vendor or marketer during different consumer events in the digital channels. During each event in the digital channel, various attributes related to the digital channel and the event may be retrieved. Such event attributes may include the consumer's IP address, the website the consumer came from (e.g., Google®), the particular webpage on the vendor's site that the consumer reached, the full search text request from the consumer used to reach the webpage (i.e., all keywords typed into Google®), the type and/or the characteristics (e.g., version) of the consumer's browser, etc.

As mentioned above, vendors may sometimes have a number of alternative ways to promote a given product to consumers. A vendor may promote the same product using different marketing content (e.g., different ads) presented through different marketing channels (e.g., sent over e-mail or text message, displayed on a webpage, embedded into a mobile app or a desktop application, etc.) In other words, a vendor may promote the same product using a number of “marketing creatives” where each creative is associated with a particular marketing content and a particular marketing channel. Displaying the marketing creatives to the users and any interactions by the users with the marketing creatives may also be considered events in the digital channel. Accordingly, in some examples, a consumer may be associated with one or more event attributes identifying the marketing creative that was used to attract the consumer, such as an attribute identifying the marketing content (e.g., a URL of an advertisement page) and/or an attribute identifying the marketing channel. In some examples, event attribute data related to the various event attributes may be stored in a CRM database (e.g., databases 20, 80, etc.) of the vendor or marketer.

The processed data may include any type of information related to a group of potential consumers that is of interest to the marketer. In some examples, the processed data includes at least one attribute related to each of the consumers in the dataset (in many situations the data may include a plurality of attributes for each of the consumers), an attribute value of the at least one attribute for each consumer, and a context (e.g., a KPI) used to define the at least one attribute for each consumer. Information about the KPI may be included in the initial dataset received by the processor or may be provided by the vendor or marketer.

The control unit 33 may perform cleansing and/or enhancement on the processed data. In other words, the control unit 33 may amend or remove data that is incorrect, incomplete, improperly formatted, duplicated, etc. For example, the control unit 33 may remove unique attribute information for each consumer (e.g., the IP address of each consumer), or information that has same attribute values (e.g., the name of the website that the consumer used to reach the vendor's website). In addition, the control unit 33 may enhance or supplement the initially received data with supplementary data. In some examples, the supplementary data may include demographic, socio-economic data, or any other type of the data related to the consumers. For instance, when the dataset is collected during events in the digital channel, the vendor may collect the IP addresses of the potential consumers. The IP address of the consumer may be used to extrapolate the demographic and socio-economic attributes indexed to each consumer's geographic attributes (e.g., zip code). Such demographic and socio-economic attributes may include average income for consumers in that geographical area, average number of children, average age, etc.

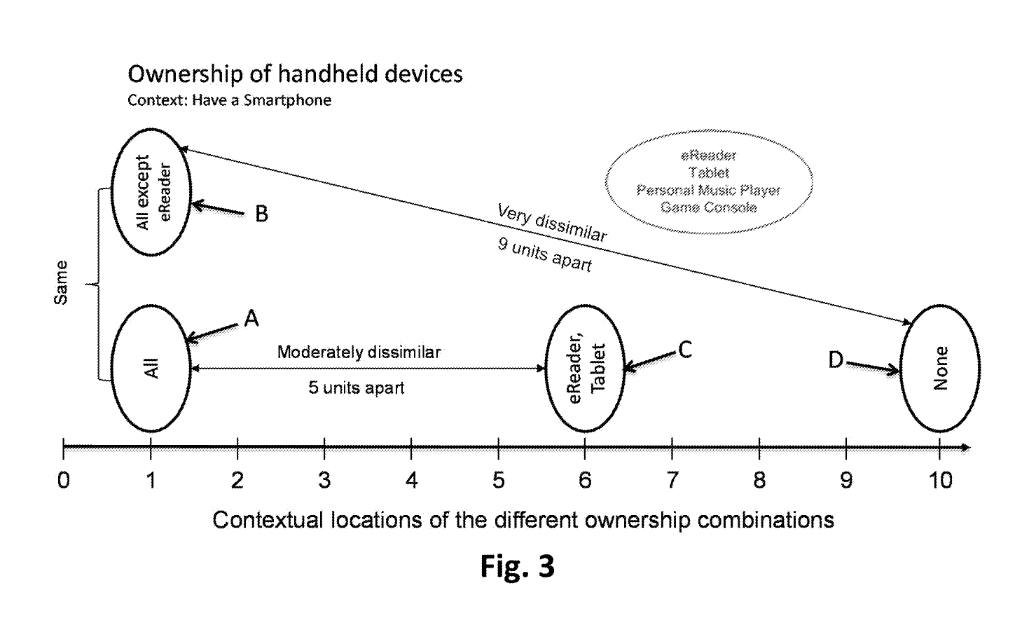

FIG. 3 illustrates an example contextual space for at least one attribute related to a plurality of consumers. The contextual space is a non-Euclidean topological space over the values of at least one attribute. As explained in additional detail below, the contextual space may define a metric derived from probability distribution of the KPI given the attribute's values for each consumer. The method 100 is described in relation to the example contextual space of potential consumers illustrated in FIG. 3. It is to be understood, that the example shown on FIG. 3 represents only one sample scenario and that the method 100 may be applied to any other analysis that involves different KPI's and/or attributes. In the example shown in FIG. 3, the context or KPI of the marketer is to identify which of the potential consumers included in the processed dataset own a smartphone. The control unit 33 processes data where potential consumers were asked to identify the specific number of electronic devices they own from a list of four possible electronic devices—an eReader, a tablet, a personal music player, and a game console. In that example, the attribute related to each of the consumers is the answer to the question—“which of the following devices do you own?” The attribute value of that attribute is the possible combination of the four devices that each of the consumers owns.

With continued reference to FIG. 2, the control unit 33 defines the at least one attribute based on a probability distribution of the context (e.g., KPI) in relation to the attribute values of the at least one attribute for all consumers (at 120). In other words, the control unit 33 constructs a contextual space for the at least one attribute (or for each of the attributes when more attributes are available) related to each consumer, where the contextual space defines the at least one attribute based on a probability distribution of the KPI in relation to all attribute values of the at least one attribute for all consumers. In the example shown in FIG. 3, the attribute (i.e., “which of the following devices do you own”) for each consumer is defined by the probability distribution of the KPI (i.e., have a smartphone) in relation of the attribute values (i.e., the possible combination of devices owned by the consumers) of the attribute for all consumers.

In the example shown in FIG. 3, the desired KPI is represented by the zero value on the illustrated axis. Further, FIG. 3 illustrates four possible attribute values A, B, C, and D for the at least one attribute. Attribute value A indicates that a consumer owns all four electronic devices, B indicates that a consumer owns all devices except eReader, C indicates that a consumer owns only an eReader and a tablet, and D indicates that a consumer owns none of the four electronic devices. As shown in FIG. 3, the attribute values (i.e., the combinations of electronic devices owned) for the at least one attribute are used to create a contextual space for the at least one attribute based on the probability distribution of the KPI in relation to these attribute values. In other words, the proposed method imposes a “context” via the conditional probability distribution of the KPI in relation to the attribute values for that attribute. The importance of the attribute values is defined based on the KPI. The method assigns a point in the contextual space for each attribute value of each attribute for each consumer. As a result, distances in the contextual space are measured relative to that context (i.e., the KPI) and are not arbitrary imposed. The similarities of the attribute values and of the consumers are determined quantitatively in the context.

As explained in additional details below, the distance between the location of each attribute value for each consumer in relation to the KPI and a centroid of a cluster of consumers is determined by using a metric calculated based on all attribute values for the at least one attribute in relation to the context. In other words, the metric for the at least one attribute may be calculated based on the probability distribution of the context given the attribute's values of that attribute over each consumer. Thus, the distances of the attribute values are computed by using a non-Euclidean metric over the values of each attribute, where that metric depends on the KPI characterizing the attribute. In other words, the proposed method does not assume a Euclidean space that is artificially imposed on the dataset of consumers, but that space is determined based on the KPI.

Therefore, the proposed method measures the similarities between consumers within a context (i.e., the KPI). Based on the given attribute values and their relation to the KPI, the control unit 33 identifies coordinates values for each attribute for each consumer. If two attribute values are close to one another, then it can be expected that the consumers associated with these values to behave similarly in respect to the KPI. In other words, consumers that have all of the four devices (e.g., consumers with attribute value A) are more similar (from KPI prospective) to consumers that have smartphones. As illustrated in FIG. 3, such consumers are positioned at value one on the axis to indicate their close relation to the KPI. On the other hand, consumers that don't own any of the four electronic devices (e.g., consumers with attribute value D) are very dissimilar to Consumers A and B and is very unlikely that they own a smartphone.

Next, at 130, the control unit 30 determines clusters of consumers based on the probability distribution of the context in relation to the attribute values of the at least one attribute for all consumers. The clusters are determined based on the analysis of the at least one attribute in the created contextual space. In one example, determining the clusters of consumers includes identifying an optimal number of clusters.

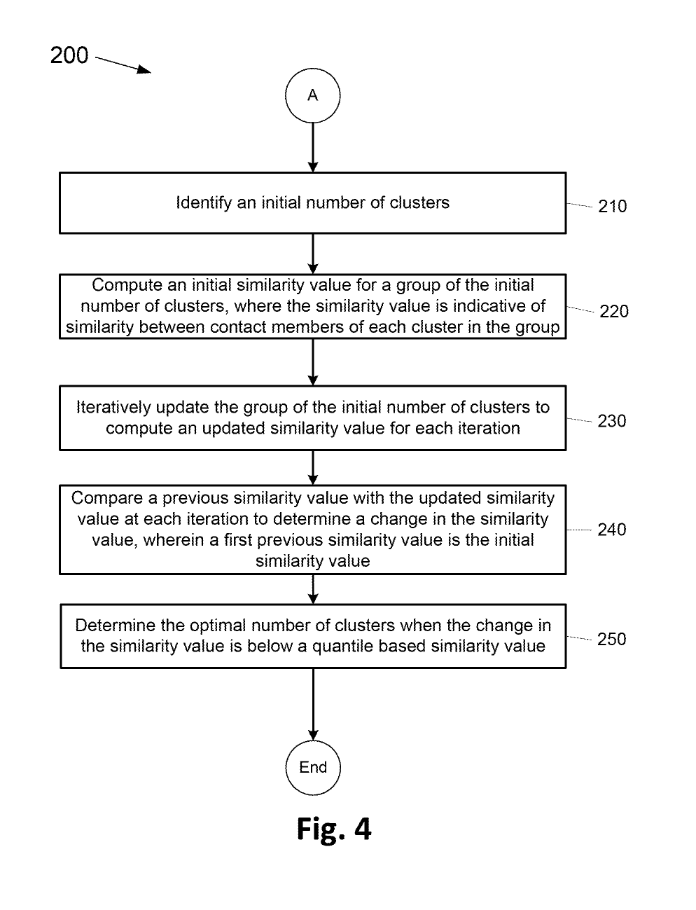

FIG. 4 illustrates a method 200 for identifying an optimal number of clusters. In one example, the method 200 can be executed by the control unit 33 of the processor 30. Various elements or blocks described herein with respect to the method 200 are capable of being executed simultaneously, in parallel, or in an order that differs from the illustrated serial manner of execution. The method 200 is also capable of being executed using additional or fewer elements than are shown in the illustrated examples. The method 200 may be executed in the form of instructions encoded on a non-transitory machine-readable storage medium 37 executable by the processor 30 of the computing device 10. In one example, the instructions for the method 100 implement the cluster determination module 40.

The method 200 begins at 210, where the control unit 33 identifies an initial number of clusters for the originally processed dataset of consumers. In one example, the initial number of clusters is identified based on a combination of domain expertise and/or educated guessing by the marketer. In other examples, the initial number of clusters may be automatically identified by the control unit 33 based on the number of consumers, number of attributes, and other factors. For instance, the marketer or the control unit may identify twenty initial clusters that are used to determine the optimal number of clusters. The clusters of consumers may be overlapping significantly and the goal of the method 200 is to maximize the distance between the individual clusters in order to identify consumers with similar attribute values in relation to the KPI.

Next, at 220, the control unit 33 computes an initial similarity value for a group of the initial number of clusters, where the similarity value is indicative of a similarity among the clusters in the group. Ideally, consumers within each cluster must have very similar characteristics (e.g., attribute values) to one another. In one example, the control unit 33 first computes the initial similarity value for a group of at least two clusters. Various processes can be used to compute the similarity value for the group of clusters. In one example implementation, the similarity value for the group of clusters is determined by computing the ratio or variance of within-cluster sum of squares and between-cluster sum of squares for the group of clusters. That way, the control unit compares the similarity between the two clusters based on the attribute values of the consumers and their relation to the KPI in the contextual space.

At 230, the control unit 33 iteratively updates the group of the initial number of clusters to compute an updated similarity value for each iteration. For example, the group of clusters (e.g., two clusters) is updated with one cluster to include three clusters. An updated similarity value is computed for the updated group of clusters. This process is performed for every iteration until the last possible cluster of the initial number of clusters is added to the group. In other words, during each iteration, the group of clusters is updated from the previous iteration (e.g., by adding one cluster) and an updated similarity value for the group of clusters is calculated.

At 240, the control unit 33 compares a previous similarity value with the updated similarity value at each iteration to determine a change in the similarity value. In one example, the first previous similarity value is the initial similarity value (e.g., for the first group of two clusters). In other words, the control unit 33 calculates the change in the similarity value by determining the difference between the updated similarity value for every new iteration and the previous similarity value from the previous iteration (e.g., the similarity value for the group of three clusters is compared to the previous similarity value for the group of two clusters). That way, the control unit 33 obtains a list of similarity values from all iterations and a corresponding list of the differences of similarity values between successive iterations.

Next, at 250, the control unit 33 determines an optimal number of clusters when the change in the similarity value is below a quantile based similarity value. In addition, the control unit 33 also determines the centroids of these clusters. For example, the control unit arranges the differences in the similarity values in descending order, computes a quantile based similarity value (e.g., a median) of all differences, and compares the differences to the quantile based similarity value. When the difference between two successive iterations is below the quantile based similarity value, the control unit 33 selects the corresponding number of clusters in that group to determine the optimal number of clusters.

Therefore, the optimal number of clusters is based on the input data processed by the processor, the KPI identified by the marketer, and the position of the attribute values for the attributes in the contextual space. In other words, the consumers in these clusters have similar attribute values and are likely to behave similarly with respect to the KPI. However, these clusters may be overlapping (i.e., several clusters may include attribute values/consumers that are the same or very similar). The ultimate goal of the marketer is to identify the most valuable segments of consumers, which include consumers with very close characteristics (based on the alignment between their attribute values and the KPI). Thus, the proposed method uses additional techniques to further separate the identified clusters and to construct segments of similar consumers that do not overlap.

With continued reference to FIG. 2, the control unit 33 constructs a plurality of segments of similar consumers by using the clusters (at 140). That process creates a plurality of segments of similar consumers that have comparable attribute value positions in the contextual space, and therefore, are likely to act similarly with respect to the KPI.

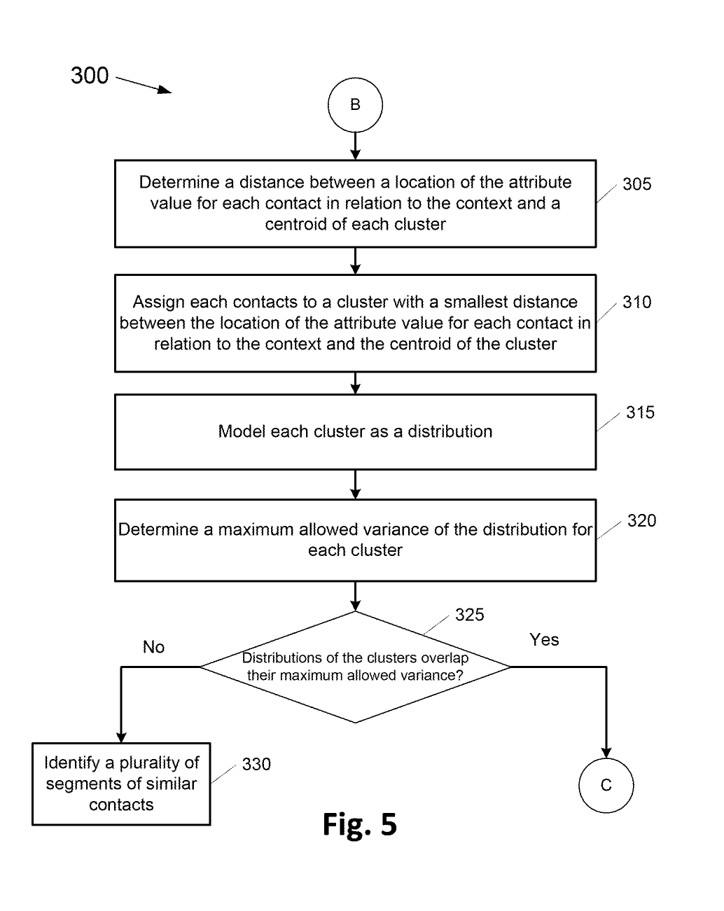

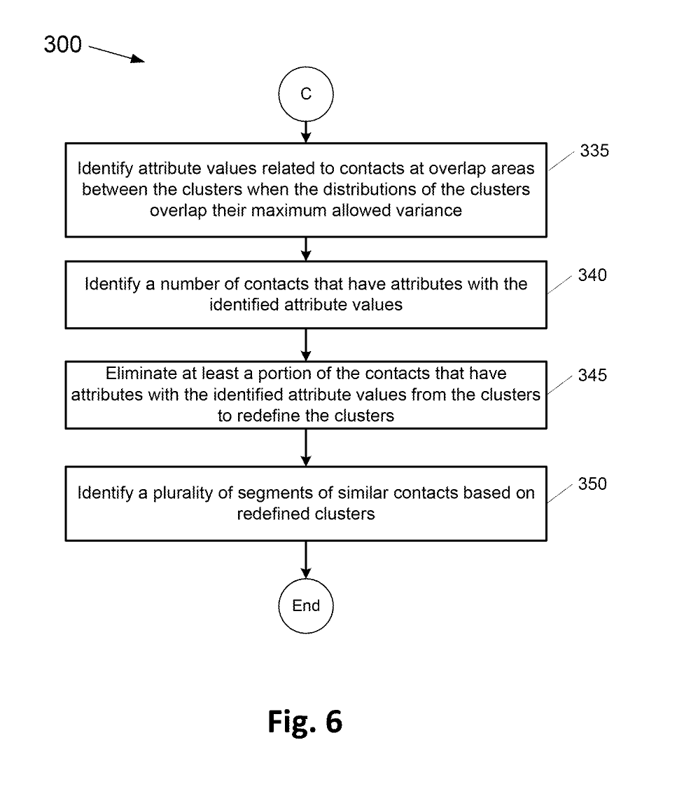

FIGS. 5 and 6 illustrate a method 300 for constructing a plurality of segments of similar consumers by using the clusters identified by the method 200. In one example, the method 300 can be executed by the control unit 33 of the processor 30. Various elements or blocks described herein with respect to the method 300 are capable of being executed simultaneously, in parallel, or in an order that differs from the illustrated serial manner of execution. The method 300 is also capable of being executed using additional or fewer elements than are shown in the illustrated examples. The method 300 may be executed in the form of instructions encoded on a non-transitory machine-readable storage medium 37 executable by the processor 30 of the computing device 10. In one example, the instructions for the method 100 implement the segmentation module 41.

The method 300 begins at 305, where the control unit 33 determines a distance between a location of the attribute value for each consumer (e.g., attribute values A-C of FIG. 3) in relation to the context (i.e., the KPI) and the centroid of each cluster. In one example, the distance is determined by using a metric calculated based on all attribute values for the at least one attribute in relation to the KPI. For instance, the control unit may compute the metric based on the KPI probability distribution. In the example dataset shown in FIG. 3, the metric may be computed based on all of the attribute values for the attribute and the resulting probability that each possible value corresponds to the KPI (i.e., the consumer owns a smartphone). Thus, the metric is computed based on all attribute values for all consumers in the dataset (when the dataset includes more than one attribute per consumer).

The following formula may be used to determine the distance between the location of the attribute value for each consumer in relation to the context KPI and the centroid of each cluster:

Δs=\sqrt{g_{μv}(z)Δz^{μ}Δz^{v}}

In the formula, Δs is the distance between the two points (i.e., the location of the attribute value for each consumer in relation to the context KPI and the centroid of each cluster), g is the metric that is used, z is the value of an attribute, and pi and v are indices over the attributes with a sum over said attributes implied. Thus, the value of the metric may vary not only by attribute but also by the value of attribute.

At 310, the control unit 33 assigns each consumer from the dataset to a cluster with a smallest distance between the location of the attribute value for each consumer in relation to the context and the centroid of the cluster. Therefore, the control unit may reassign some of the consumers to different clusters and other consumers may stay in the clusters that they were originally placed. At 315, the control unit 33 models each of the identified clusters as a distribution. In other words, the control unit may create a distribution model for each cluster based on the attribute values for the consumers included in the cluster. Various distribution techniques may be used to model each of the clusters as distributions (e.g., normal or Gaussian distribution, etc.).

Next, the control unit 33 determines a maximum allowed variance of the distribution for each cluster (at 320). Thus, the modeled distributions for each cluster may include information about: 1) the mean value for the attribute values in that cluster; 2) the maximum allowed variance for that distribution. The maximum allowed variance for each distribution may be computed using the metric of the KPI probability distribution in the contextual space. These parameters allow the control unit 33 to identify the tails of the distributions. This is done for all clusters. The control unit 33 then determines whether the distributions of the clusters overlap their maximum allowed variance (at step 325). In other words, the control unit 33 determines whether the tails of the distributions of the clusters intersect. If the distributions of the clusters do not overlap their maximum allowed variance, the control unit 33 identifies a plurality of segments of similar consumers based on the existing clusters (at 330). That means that the constructed segments are not overlapping and the potential consumers are grouped based on their similar association to the KPI.

If, on the other hand, the distributions of the clusters overlap their maximum allowed variance, the control unit 33 proceeds to 335. Overlapping of the maximum allowed variance of the cluster distributions means that there is overlap between the clusters. At 335, the control unit 33 identifies attribute values related to consumers at overlap areas between the clusters. In other words, the values of the attributes related to each consumer are identified in the places of intersection between the distributions (i.e., clusters).

Next, the control unit 33 identifies a number of consumers that have attributes with the identified attribute values (at 340). The number of these consumers may vary depending on the initial dataset, the attribute values, the KPI, etc. At 345, the control unit 33 eliminates at least a portion of the consumers that have attributes with the identified attribute values from the clusters to redefine the clusters. In other words, if consumers that were assigned to a cluster fall outside of the maximum allowed variance of the distribution, they are “dropped” from the cluster and are placed into a set of “orphans.” In some examples, the control unit 33 may eliminate a predetermined number of “orphans” such that the set of eliminated consumers does not exceed a predetermined value or a percentage of the total number of potential consumers. Alternatively, the control unit 33 may merge at least two clusters into a single cluster when these two clusters overlap significantly.

At 350, the control unit 33 identifies a plurality of segments of similar consumers based on the redefined clusters. In other words, the resulting redefined clusters of consumers are identified as segments that can be targeted by the marketer to offer different products or services using different marketing creatives. The control unit 33 may further characterize the identified segments. For example, the control unit may determine the values of the at least one attribute that are most likely (i.e., have a relatively high probability) to be found in each segment and the attribute values that are indicative of the segment (i.e., a consumer with those values will most likely be classified in that segment).

In one example implementation, the control 33 unit may compute a probability of each attribute included in the segment (when the segment includes more than one attribute) and a probability of the each attribute value for each attribute included in the segment. These probabilities may be computed based on the number of consumers in the segment associated with that attribute or with the attribute value, as compared to the number of consumers in all segments associated with that attribute or with the attribute value. Only the attributes and the attribute values that stand out are used to characterize the segment. Considering the example in FIG. 3, the attribute value A (consumer owns all four device) may be considered unique to a segment and may be used to characterize that segment.

Information about the processed dataset, the identified segments, and the consumers, may be presented in various ways. In one example, the output from the control unit may consists of tables with: (a) a summary of the KPI performance and the size of each segment; (b) each consumer's segment membership (i.e., the segment to each consumer is placed), consumer's distance from the segment-centroid, and consumer's corresponding percentile rank; and (c) the characteristic attributes for each segment, measured relative to the optimal KPI.

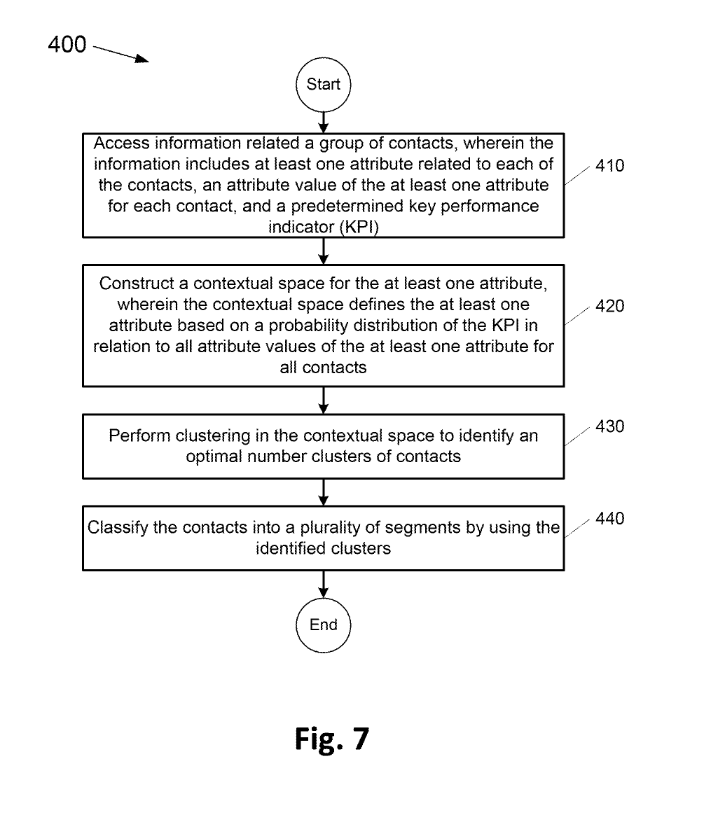

FIG. 7 illustrates a flow chart showing an example of an alternative method 400 for constructing market segments of consumers in accordance with an implementation of the present disclosure. In one example, the method 400 can be executed by the system 5 that includes the computing device 10. The method 400 may be executed with the contextual space construction module 39, the cluster determination module 40, and the segmentation module 41, where these modules are implemented with electronic circuitry used to carry out the functionality described below. Various elements or blocks described herein with respect to the method 400 are capable of being executed simultaneously, in parallel, or in an order that differs from the illustrated serial manner of execution.

The method 400 begins at 410, where the system 5 is to access information related a group of consumers. That step is similar to step 110 of the method 100 and the information includes at least one attribute related to each of the consumers, an attribute value of the at least one attribute for each consumer, and a predetermined KPI. Next, the systems 5 is to construct a contextual space for the at least one attribute related to each consumer (at 420). The contextual space defines the at least one attribute based on a probability distribution of the KPI in relation to all attribute values of the at least one attribute for all consumers. That step is similar to step 120 of the method 100.

At 430, the system 5 is to perform clustering in the contextual space to identify optimal number clusters of consumers. This step involves processes that are similar to the processes described in respect to method 200. Based on the identified optimal number of clusters, the system 5 is to classify the consumers into a plurality of segments (at 440). That step is similar to the processes described in respect to method 300.

As discussed above, in some examples, at least one of the attributes characterizing a consumer may be a marketing creative associated with the consumer, such as a marketing creative that was used to attract the consumer and/or caused the consumer to buy a certain product. Thus, in some examples, the marketing creative is taken into account by the segment identification techniques discussed above, meaning that the consumers may be classified into segments based at least in part on the marketing creatives associated with the consumers and based on how those marketing creatives relate to the context. Thus, if two consumers are associated with two marketing creatives whose attribute values are close to each other in relation to the context (e.g., the KPI), the two consumers may be more likely to be assigned to the same segment, and vice versa. In some examples, each segment may be characterized by a representative marketing creative, such as the most popular marketing creative among the segment's consumers.

The methods discussed above may be used to define segments for a given context (e.g., for a given KPI). Similarly, the methods discussed above may also be used to define segments for a number of different contexts, where each context may be associated with a different KPI. For example, a vendor may have several products or services (collectively referred to herein as “promoted items”), and the vendor may want to treat each promoted item (or each subset of the promoted items) as a separate context. Accordingly, the vendor may define a plurality of contexts, each context being associated with at least one promoted item and with a set of one or more consumer clusters and segments defined based on that context. Because each context may be associated with a different promoted item (and a different KPI), and because a context's metric and a contextual space depends on the context (and its KPI), it is appreciated that in some examples different contexts may have different metrics and different contextual spaces.

In some examples, the methods described above may be applied to different contexts and generate context information related to a plurality of contexts. The context information may be stored in and retrieved from database 80, database 20, or any other type of database. The stored context information may include, for each context, information about the promoted item(s) associated with the context and information related to the contextual space and the distance metric calculated for that context. The stored context information may also include information describing the segments and/or clusters defined for the context, such as each segment's and/or cluster's centroid, representative marketing creative, etc. In some examples, the context information describing the different predetermined contexts may be used to determine which predetermined context best matches a particular consumer, and thus determine which items (e.g., products or services) should be offered to the consumer. In addition, the context information may be used to determine which segment among the segments of the best-matching context best matches the particular consumer, and to use that segment's representative marketing creative to promote the determined items.

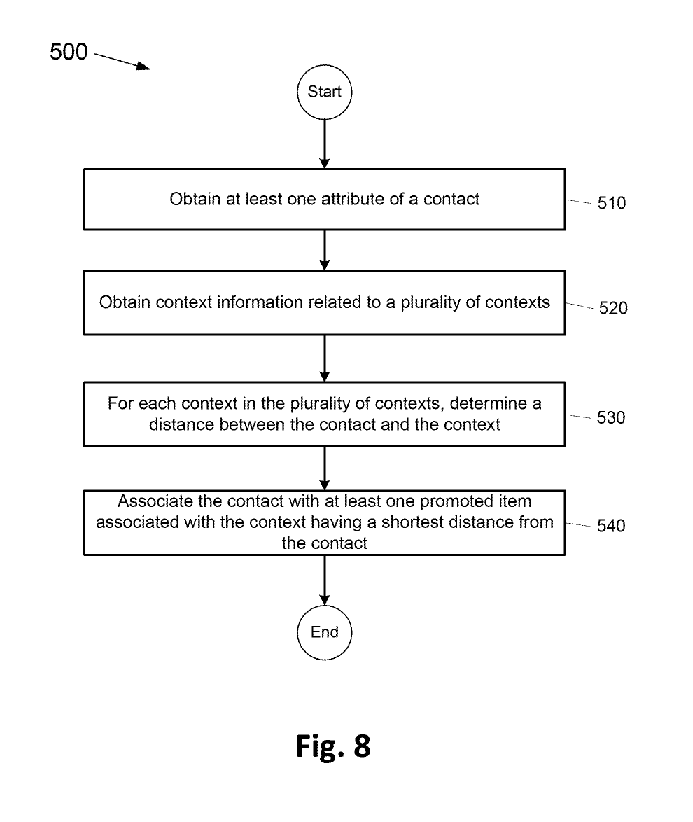

FIG. 8 illustrates a flow chart showing an example of a method 500 for associating a contact with at least one promoted item. In one example, the method 500 may be executed by the control unit 33 of the processor 30 of the computing device 10. Various elements or blocks described herein with respect to the method 500 are capable of being executed simultaneously, in parallel, or in an order that differs from the illustrated serial manner of execution. The method 500 is also capable of being executed using additional or fewer elements than are shown in the illustrated examples.

The method 500 may be executed in the form of instructions encoded on a non-transitory machine-readable storage medium 37 executable by the processor 30 of the computing device 10. In one example, the instructions for the method 500 implement the contact association module 42. In other examples, the execution of the method 500 may be distributed between the processing device 30 and other processing devices in communication with the processing device 30. In the implementation related to FIG. 8, the computing device 10 may be a device of a vendor or a marketer and may be controlled by the vendor or the marketer. Alternatively, the computing device 10 may be operated by a third party that provides services to a vendor or a marketer.

The method 500 begins at block 510, where the processor 30 may obtain at least one attribute of a contact (e.g., of a new consumer entering a digital channel) and at least one attribute value of the at least one attribute. It is appreciated that in some examples, the processor 30 may obtain, for a contact, a plurality of attributes and their respective attribute values. At block 520 the processor may obtain context information related to a plurality of contexts, where some or all the context information may have been generated by methods discussed above (e.g., methods 100, 200, 300, and 400). In some examples, the processor may obtain the context information from a database, such as database 20 or database 80.

The obtained context information may describe, for each context, the set of one or more predetermined segments associated with the context. For example, the context information may include each segment's centroid and/or other information about the segment, such as the probability distribution of attribute values of contacts assigned to the segment. The obtained context information may also describe for each context its distance metric and/or its contextual space. For example, context information may include a map or a mapping formula based on which a given attribute having a given attribute value can be mapped into the contextual space of the context. The obtained context information may also identify, for each context, one or more promoted items (e.g., products or services) associated with the context.

At block 530, the processor 30 may determine a distance between the contact and each context in the plurality of contexts. In some examples, the distance between the contact and a context may be determined by calculating the distance between the contact and each of the context's segments and determining the shortest of those distances. In other words, the distance between the contact and a context may be defined as the shortest distance between the contact and one of the context's segments. It is appreciated that in other examples, the distance between the contact and a context may be defined differently. For example, the distance may be defined as a function (e.g., an average or a median) of distances between the contact and all of the context's segments.

In some examples, the distance between a contact and a context's segment may be calculated using the distance metric associated with the context. For example, to calculate the distance between the contact and the segment, the processor 30 may determine the location of the contact's attributes in the contextual space of the context (e.g., using the context's map or mapping formula), and use the context's distance metric to measure the distance between that location and the location of the segment's centroid in the contextual space. As discussed above, the contextual space may be a non-Euclidean topological space, and each context may have a different contextual space and a different distance metric. In some examples, the number of contact attributes received at block 510 may be different than the number of attributes associated with the context's contextual space and the context's distance metric. In these examples, some of the contact's attributes and/or some of the context's attributes may be omitted, and the mapping and the distance calculations described above may be performed using attributes that are associated with the contact as well as the contextual space and the metric associated with the context.

At block 540, after determining a distance between the contact and each context in the plurality of contexts, the processor 30 may associate the contact with the context having a shortest distance from the contact. More specifically, the processor 30 may associate the contact with at least one promoted item (or all promoted items) associated with that context.

In some examples, after associating the contact with at least one promoted item, the processor 30 may provide to the contact information (e.g., promotional material) related to the promoted item. For example, the processor 30 may determine a marketing creative associated with the segment having the shortest distance from the contact among all segments associated with the context associated with the contact, i.e., the context having the shortest distance from the contact. Depending on the manner in which a distance between the context and the contact is determined, this may include determining a marketing creative associated with the segment having the shortest distance from the contact among all segments associated with all contexts.

In some examples, the processor 30 may first determine the segment having the shortest distance from the contact as discussed above, and then determine the marketing creative associated with that segment, which may include determining the segment's representative marketing creative. The processor 30 may determine the segment's representative marketing creative, for example, based on marketing creatives of all the contacts within the segment. For example, the processor 30 may determine the most popular marketing creatives as the representative marketing creative. In some examples, the representative marketing creative may be predetermined and stored in a database (e.g., stored in database 20 or 80 as part of the context information of the segment's context), in which case the processor 30 may retrieve the predetermined marketing creative from the database. In some examples, the marketing creative may identify a marketing content (e.g., marketing content related to the promoted item(s) associated with the context) and a marketing channel (e.g., email, website, mobile app, etc.) and the processor 30 may provide the identified marketing content to the contact via the identified marketing channel.

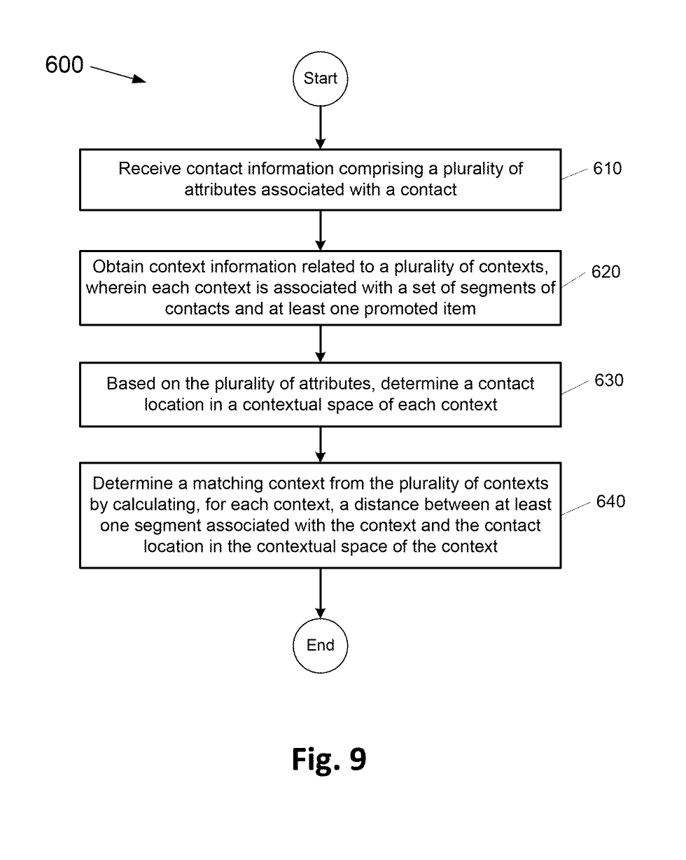

FIG. 9 illustrates a flow chart showing an example of another method 600 for determining a matching context for a contact in accordance with an implementation of the present disclosure. In one example, the method 600 can be executed by the system 5 that includes the computing device 10. The method 600 may be implemented, for example, by the contact association module 42, which may be implemented with electronic circuitry used to carry out the functionality described below. Various elements or blocks described herein with respect to the method 600 are capable of being executed simultaneously, in parallel, or in an order that differs from the illustrated serial manner of execution.

The method 600 begins at 610, where the system 5 may receive contact information comprising a plurality of attributes associated with a contact. At block 620, the system 5 may obtain context information related to a plurality of contexts, where each context is associated with a set of segments of contacts and at least one promoted item. At block 630, the system 5 may determine, based on the plurality of attributes, a contact location in a contextual space of each context. At block 640, the system 5 may determine a matching context from the plurality of contexts. As discussed above, in some examples, determining a matching context may be achieved by calculating, for each context, a distance between at least one segment associated with the context and the contact location in the contextual space of the context, where the distance is calculated using the distance metric associated with the context. At block 650, the system 5 may output information related to the promoted item associated with the matching context.

What is claimed is:

1. A method comprising:
obtaining at least one attribute of a contact;
obtaining context information related to a plurality of contexts, wherein each context is associated with a set of segments of contacts, a distance metric, and at least one promoted item;
for each context in the plurality of contexts, determining a distance between the contact and the context by determining, using the distance metric associated with each context, a shortest distance between the contact and each of the segments associated with the context; and
associating the contact with the at least one promoted item associated with the context having a shortest distance from the contact.

2. The method of claim 1, wherein each contact of each segment of at least one context is associated with at least one attribute value for the at least one attribute, and wherein the distance metric associated with the at least one context is calculated based on attribute values associated with all contacts of all segments of the at least one context.

3. The method of claim 1, wherein determining the shortest distance between the contact and each of the segments comprises determining a shortest distance between a location of the contact, as specified by an attribute value of the at least one attribute in relation to the context, and a centroid associated with each of the segments.

4. The method of claim 1, wherein the contact is associated with a plurality of attributes, and wherein determining the shortest distance between the contact and each of the segments associated with the context comprises determining, using the distance metric, a shortest distance in a non-Euclidian topological space, between a location of attribute values of the plurality of attributes in relation to the context and a centroid associated with each of the segments, wherein the distance is calculated using the distance metric in a non-Euclidian contextual space of the context.

5. The method of claim 1, further comprising:
determining a marketing creative associated with the segment having the shortest distance from the contact among all segments associated with the context having the shortest distance from the contact.

6. The method of claim 5, wherein the marketing creative comprises a marketing content and a marketing channel, and wherein the method further comprises providing the marketing content to the contact via the marketing channel.

7. The method of claim 1, wherein each context in the plurality of contexts is a key performance indicator (KPI) associated with the at least one promoted item associated with the context.

8. A system comprising a computing device having at least one processing device with a control unit to:
receive contact information comprising a plurality of attributes associated with a contact;
obtain context information related to a plurality of contexts, wherein each context is associated with a set of segments of contacts and at least one promoted item;
based on the plurality of attributes, determine a contact location in a contextual space of each context;
determine a matching context from the plurality of contexts by calculating, for each context, a distance between at least one segment associated with the context and the contact location in the contextual space of the context, wherein the distance is calculated using the distance metric associated with the context; and
output information related to the promoted item associated with the matching context.

9. The system of claim 8, wherein determining the matching context comprises selecting, from the plurality of contexts, a context associated with a segment having the shortest distance from the contact location in the contextual space of the context.

10. The system of claim 9, wherein the control unit is further to output information about a marketing creative associated with the segment having the shortest distance from the contact location in the contextual space of the context.

11. The system of claim 9, wherein the control unit is further to provide information about the promoted item to the contact using a marketing material associated with the segment having the shortest distance from the contact location in the contextual space of the context.

12. The system of claim 8, wherein each context in the plurality of contexts has a different contextual space and is associated with a different distance metric.

13. The system of claim 8, wherein each context in the plurality of contexts is a key performance indicator (KPI) associated with the at least one promoted item associated with the context.

14. A non-transitory machine-readable storage medium encoded with instructions executable by a processor, the machine-readable storage medium comprising instructions to:
receive contact information comprising a plurality of attributes associated with a contact;
obtain context information related to a plurality of contexts, wherein each context is associated with a set of segments of contacts and a key performance indicator (KPI) associated with at least one offered item;
determine, for each context in the plurality of contexts, a distance between the contact and the context, where the distance is measured in a contextual space of the context using a distance metric associated with the context; and
output information related to the at least one promoted item associated with the context having a shortest distance from the contact.

15. The non-transitory machine-readable storage medium of claim 14, wherein the instructions are further to:
output information related to a marketing creative associated with one of the segments associated with the context having the shortest distance from the contact.
